(19) United States
(12) Patent Application Publication
(10) Pub. No.: US 2006/0244736 A1
(43) Pub. Date: Nov. 2, 2006

(54) TOUCH SCREEN LIQUID CRYSTAL DISPLAY DEVICE AND SYSTEM DRIVING METHOD THEREFOR

(76) Inventor: Ching-Wu Tseng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,258

(22) Filed: Jul. 28, 2005

(30) Foreign Application Priority Data
Apr. 28, 2005 (TW) 94113625

(51) Int. Cl. G09G 5/00

(52) U.S. Cl. 345/173

(57) ABSTRACT

A touch screen liquid crystal display (LCD) device is provided. In its design, a LCD panel and an input panel are integrated, to prevent damages or impurity contamination in the manufacturing and assembly process of the LCD, further to spare the additional analog-to digital converter and control circuit. With the driving method of the present invention, the touch screen LCD device with integrated display and input function doesn't affect the original LCD display function. Moreover, the simple on/off driving mode also enhances the resolution requirement of the touch screen LCD.

### CROSS-REFERENCE TO RELATED APPLICATION

This application claims the priority benefit of Taiwan application serial no. 94113625, filed on Apr. 28, 2005. All disclosure of the Taiwan application is incorporated herein by reference.

### BACKGROUND OF THE INVENTION

1. Field of Invention

The present invention relates to a liquid crystal display (LCD), and particularly to a LCD touch screen input circuit and the system driving method therefor.

2. Description of the Related Art

A conventional LCD employs a source driver and a gate driver to form a timing control circuit as an essential portion for driving the screen. To design a LCD with touch screen functions, however, in addition to the LCD panel and timing control circuit, it is necessary to add a touch screen panel for receiving touch screen commands, an analog-to-digital converter (ADC) for converting the analog commands input from the touch screen panel into encodable digital signals and a touch screen input control circuit for processing the input digital signals. All the above-mentioned components are combined to form a LCD with touch screen input functions.

As shown in FIG. 1, a conventional LCD with touch screen input functions includes a LCD panel 110, a vertical line source driver 120, a horizontal line gate driver 130, an input panel 140, a timing control circuit 150, an analog-to-digital converter (ADC) 160 and an input control circuit 170. When assembling the system, it is required that the LCD panel 110 be aligned with the input panel 140 to ensure precise correspondence between touch screen input and image output. Since the input panel 140 works with the ADC 160, when the touch screen function is to be applied in a high resolution LCE, the manufacturing difficulty would multiply.

The disadvantages of a conventional touch screen LCD device can be summarized as follows. In terms of design and fabrication, the input panel 140 along with the input control circuit 170, and the LCD panel 110 along with the timing control circuit 150 are processed separately, which increases the manufacturing cost. Besides, the separate design and fabrication mode also increases power consumption and space occupation, which doesn't follow the current trend. To produce a qualified conventional touch screen LCD device, it is required that there be no impurity contamination on the joint surface between the LCD panel 110 and the input panel 140, and the resistance on the input panel 140 be evenly distributed. To manufacture touch screen LCD devices, especially the ones with high resolution, these issues and the above-described alignment correctness have increased considerable technique difficulty.

### SUMMARY OF THE INVENTION

An object of the present invention is to provide a touch screen LCD device and a system driving method therefor to substantially reduce one or a plurality of problems caused by the conventional technique limitation.

The present invention provides a touch screen LCD device. The device includes a plurality of touch screen LCD units, each of which includes a touch-point circuit activated by an input of a medium for producing a short-circuit current signal; a pixel unit used for receiving and storing a gray-level voltage signal; a scanning touch screen horizontal line used for transmitting a scanning voltage signal to turn on/off the pixel unit and transmitting the signal of the touch screen horizontal line; a touch screen horizontal line used for receiving a first voltage signal and transmitting the short-circuit current signal; a gray-level touch screen vertical line used for receiving a second voltage signal and a gray-level voltage signal plus transmitting the short-circuit current signal; a driving region which includes a bidirectional horizontal line driver circuit used for outputting the scanning voltage signal and the first voltage signal plus receiving the short-circuit current signal, and a bidirectional vertical line driver circuit used for outputting the gray-level voltage signal and the second voltage signal plus receiving the short-circuit current signal; and a plurality of switch units, each of which includes a high-voltage switch for turning on/off the bidirectional horizontal line driver circuit and the adjacent touch screen horizontal line, and a control signal for switching on/off the high-voltage switch.

At an intersection point of projections of the touch screen horizontal line and the gray-level touch screen vertical line in an embodiment is a touch-point circuit. When the touch-point circuit gets short-circuit, the first voltage signal and the second voltage signal provide a required voltage, at different time respectively, for the touch-point circuit to produce a short-circuit current signal.

The touch-point circuit in another embodiment can become a short-circuit or an open-circuit depending on an input of at least one of the media, such as a light source, an electric field and a magnetic field. Moreover, as the touch-point circuit becomes a short-circuit, a short-circuit current signal is generated.

In the bidirectional horizontal line driver in another embodiment, a same circuit is in charge of both receiving and outputting signals.

In the bidirectional horizontal line driver in another embodiment, two sets of circuits are in charge of receiving and outputting signals, respectively.

In the bidirectional vertical line driver in another embodiment, a same circuit is in charge of both receiving and outputting signals.

In the bidirectional vertical line driver in another embodiment, two sets of circuits are in charge of receiving and outputting signals, respectively.

The high-voltage switch in another embodiment comprises at least one of a N-MOS (N-type metal oxide semiconductor) and a P-MOS (P-type metal oxide semiconductor).

The high-voltage switch in another embodiment comprises a CMOS (complementary metal oxide semiconductor).

A system driving method provided by another embodiment is suitable for a touch screen LCD device. The method includes the following steps. First, an electric variation of a touch-point circuit caused by an input change produces a short-circuit current signal. Second, a control signal determines the turning on/off of a high-voltage switch. Third, when the high-voltage switch is on, the period is divided into a first time segment and a second time segment. Fourth, when a control signal turns on the high-voltage switch, during the first time segment the bidirectional horizontal line driver outputs a first voltage signal, further produces a short-circuit current signal if the touch-point circuit gets short-circuit, and transmits the short-circuit current signal to a gray-level touch screen vertical line. Fifth, when a control signal turns on the high-voltage switch, during the second time segment the bidirectional vertical line driver outputs a second voltage signal, further produces a short-circuit current signal if the touch-point circuit gets short-circuit, and transmits the short-circuit current signal to a touch screen vertical line. Finally, when a control signal turns off the high-voltage switch, the bidirectional horizontal line driver outputs a scanning voltage signal, while the bidirectional vertical line driver outputs a gray-level voltage signal.

The input variation in another embodiment is caused by at least one of the media, such as a light source, an electric field and a magnetic field.

The control signal provided by another embodiment turns on a high-voltage switch with a positive high-voltage and turns off a high-voltage switch with a negative high-voltage.

The control signal provided by another embodiment turns on a high-voltage switch with a negative high-voltage and turns off a high-voltage switch with a positive high-voltage.

The control signal provided by another embodiment is a periodic signal.

The control signal provided by another embodiment is a non-periodic signal.

The high-voltage switch in another embodiment comprises at least one of a N-MOS and a P-MOS.

The high-voltage switch in another embodiment comprises a CMOS.

The first time segment specified in another embodiment is prior to the second time segment.

The second time segment specified in another embodiment is prior to the first time segment.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic drawing of a conventional LCD with touch screen input functions.

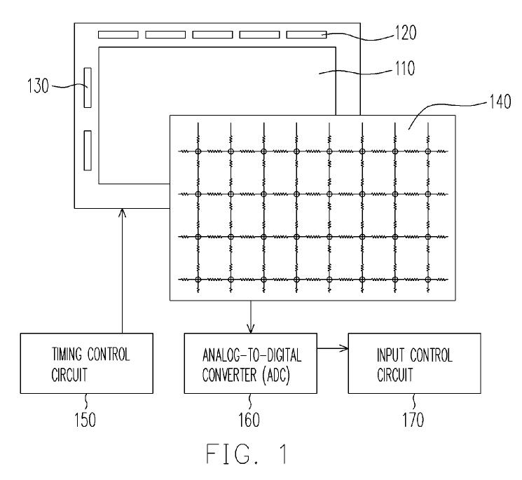

FIG. 2A is a schematic drawing of a touch screen LCD unit of the present invention.

FIG. 2B is a schematic drawing of another touch screen LCD unit of the present invention.

FIG. 3 is a schematic chart showing the driving sequence of a touch screen LCD of the present invention.

FIG. 4A is a schematic drawing of a touch screen LCD device with 480×240 resolution of the present invention.

FIG. 4B is a schematic chart showing the driving sequence of three scanning touch screen horizontal lines (G1, G2, G3) and three gray-level touch screen vertical lines (S1, S2, S3) corresponding to FIG. 4A.

### DESCRIPTION OF THE EMBODIMENTS

In the touch screen LCD device of the present invention, the input panel is integrated with the LCD panel, thus preventing the joint surface problem in the post-production a conventional touch screen LCD device. In the touch screen LCD device of the present invention, the input resolution depends on the resolution of a LCD panel. In addition, the source driver with a bidirectional driving way and the gate driver with a bidirectional driving way plus the method for driving a touch screen LCD achieves the touch screen input function.

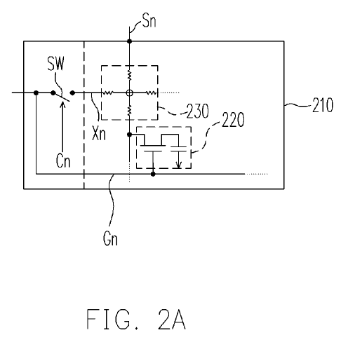

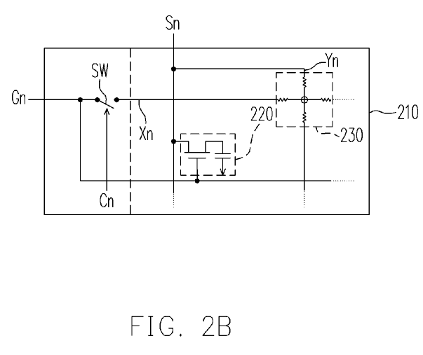

FIG. 2A is a schematic drawing of a touch screen LCD unit included inside a touch screen LCD device according to an embodiment. The layout of the touch screen LCD unit 210 is shown in FIG. 2A, including a gray-level touch screen vertical line Sn, a scanning touch screen horizontal line Gn, a touch screen horizontal line Xn, a pixel unit 220, a touch-point circuit 230, a high-voltage switch SW and a control signal Cn.

The gray-level touch screen vertical line Sn is used for receiving a second voltage signal and a gray-level voltage signal, and transmitting a short-circuit current signal. The scanning touch screen horizontal line Gn is used for transmitting a scanning voltage signal to turn on/off the pixel unit 220 and transmitting the signal of the touch screen horizontal line Xn. The touch screen horizontal line Xn is used for receiving a first voltage signal and transmitting the short-circuit signal. The pixel unit 220 is used for receiving and storing a gray-level voltage signal.

At an intersection point of projections of the touch screen horizontal line Xn and the gray-level touch screen vertical line Sn, a touch-point circuit 230 is formed. When the touch-point circuit gets short circuit, the first voltage signal and the second voltage signal provide a required voltage, at different time respectively, for the touch-point circuit to produce a short-circuit current signal. The touch-point circuit 230 is activated by an input of a medium and produces a short-circuit current signal. The medium can be a light source with a certain wavelength, or an electric field change, or a magnetic field change, etc. The medium can be fabricated in a LCD panel manufacturing process.

The high-voltage switch SW is used for turning on/off a bidirectional horizontal line driver located at the intersection of the touch screen horizontal line Xn and the scanning touch screen horizontal line Gn. The high-voltage switch SW comprises an N-MOS, or a P-MOS, or a CMOS, and or a combination of the above.

FIG. 2B is a schematic drawing of a touch screen LCD unit included inside a touch screen LCD device according to another embodiment. The layout of the touch screen LCD unit 210 is shown in FIG. 2B. The difference from FIG. 2A is that in FIG. 2B, an independent touch screen vertical line is branched from the gray-level touch screen vertical line Sn to form a touch-point circuit 230.

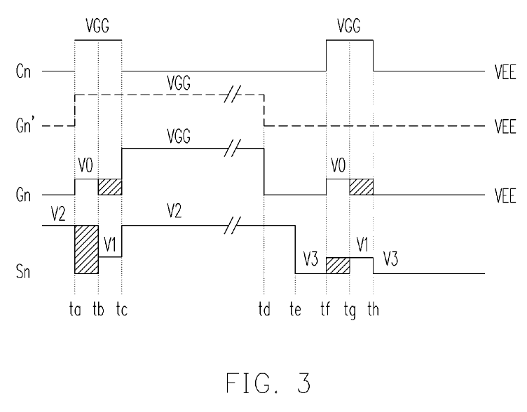

FIG. 3 is a schematic chart showing the driving sequence of a touch screen LCD of the present invention. The driving sequence includes a driving timing of the control signal Cn, a driving timing of the scanning horizontal line Gn′ of a conventional LCD, a driving timing of the scanning touch screen horizontal line Gn according to an embodiment of the present invention and a driving timing of the gray-level touch screen vertical line Sn according to an embodiment of the present invention.

Once the touch-point circuit has an electric change caused by a changed input, the driving process starts. First, a short-circuit current signal is generated in the process. Then, a control signal Cn is provided to turn on with a positive high-voltage and turn off with a negative high-voltage, or to turn on with a negative high-voltage and turn off with a positive high-voltage.

The initial value of the control signal Cn is a negative high-voltage VEE with the high-voltage switch turned off. At ta driving time, the control signal Cn is a positive high-voltage VGG with the high-voltage switch turned on. Meanwhile, the scanning horizontal line Gn′ of a conventional LCD takes the positive high-voltage VGG, the scanning touch screen horizontal line Gn takes a first voltage V0 and the bidirectional vertical line driver of the gray-level touch screen vertical line Sn shifts to receive the vertical line signal instead of outputting a gray-level voltage V2.

At tb driving time, the high-voltage switch SW is still at on status. Meanwhile, the bidirectional horizontal line driver of the scanning touch screen horizontal line Gn shifts to receive the horizontal line signal instead of outputting the first voltage V0 and the bidirectional vertical line driver of the gray-level touch screen vertical line Sn outputs a second voltage V1.

At tc driving time, the control signal Cn is a negative high-voltage VEE with the high-voltage switch SW turned off. Meanwhile, the touch-point circuit is blocked from the pixel unit, the scanning touch screen horizontal line Gn takes the positive high-voltage VGG and the gray-level touch screen vertical line Sn charges the pixel unit with the gray-level voltage V2.

At td driving time, the scanning touch screen horizontal line Gn takes the negative high-voltage VEE and the pixel unit stays at the gray-level voltage V2.

At te driving time, the bidirectional vertical line driver of the gray-level touch screen vertical line Sn outputs a gray-level voltage V3.

The driving timings at tf, tg until th are the same as at ta, tb until tc.

At th driving time, the bidirectional vertical line driver of the gray-level touch screen vertical line Sn outputs a gray-level voltage V3. Meanwhile, the scanning touch screen horizontal line Gn takes the negative high-voltage VEE and the pixel unit stays at the gray-level voltage V3.

The above-described driving sequence can be summarized as follows. When the high-voltage switch is on, the period is divided into two a first time segment (ta-tb) and a second time segment (tb-tc). When the control signal Cn keeps the high-voltage switch turned on and within the first time segment (ta-tb), a bidirectional horizontal line driver outputs a first voltage signal V0, produces a short-circuit current signal during a short circuit of the touch-point circuit, and transmits the short-circuit current signal to a gray-level touch screen vertical line Sn.

When the control signal Cn still keeps the high-voltage switch turned on and within the second time segment (tb-tc), a bidirectional vertical line driver outputs a second voltage signal V1, produces a short-circuit current signal during a short circuit of the touch-point circuit, and transmits the short-circuit current signal to a scanning touch screen horizontal line Gn.

When the control signal Cn makes the high-voltage switch turn off, the bidirectional horizontal line driver outputs a positive high-voltage VGG, then, at td, shifts to output a negative high-voltage VEE and the bidirectional vertical line driver outputs a gray-level voltage V2, then outputs a gray-level voltage V3.

The outputs from all signal wires continue until tf driving time. The driving program from tf until th is to repeat the program from ta until tc.

In the time between two consecutive turning-off status of the high-voltage switch, the scanning touch screen horizontal line Gn takes the positive high-voltage VGG and the gray-level touch screen vertical line Sn outputs the gray-level voltage. In the time between two consecutive turning-on status of the high-voltage switch SW (ta, tb until tc, and tf, tg until th) and within the first time segment, the scanning touch screen horizontal line Gn outputs a first voltage V0 for producing a short-circuit current required by the touch-point circuit of the touch screen LCD device. Meanwhile, the gray-level touch screen vertical line Sn receives the short-circuit current signal. In the time between two consecutive turning-on status of the high-voltage switch SW (ta, tb until tc, and tf, tg until th) and within the second time segment, the gray-level touch screen vertical line Sn outputs a second voltage V1 required by the touch-point circuit of the touch screen LCD device. Meanwhile, the scanning touch screen horizontal line Gn receives the short-circuit current signal.

When the control signal Cn makes the high-voltage switch turned on, there are two arrangements of the driving sequence. During the first time segment, the scanning touch screen horizontal line Gn is in an output status and the gray-level touch screen vertical line Sn is in a receiving status; then during the second time segment, the gray-level touch screen vertical line Sn is in an output status and the scanning touch screen horizontal line Gn is in a receiving status. Alternatively, during the second time segment, the scanning touch screen horizontal line Gn is in an output status and the gray-level touch screen vertical line Sn is in a receiving status; then during the first time segment, the gray-level touch screen vertical line Sn is in an output status and the scanning touch screen horizontal line Gn is in a receiving status.

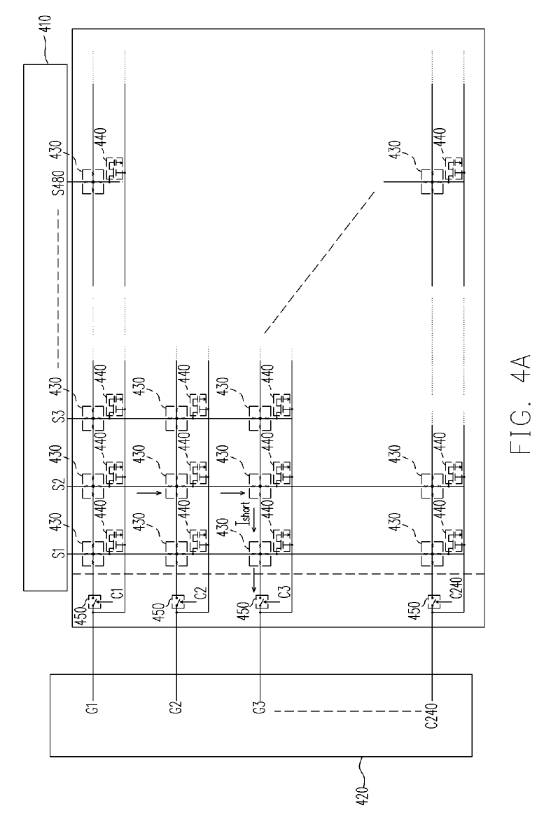

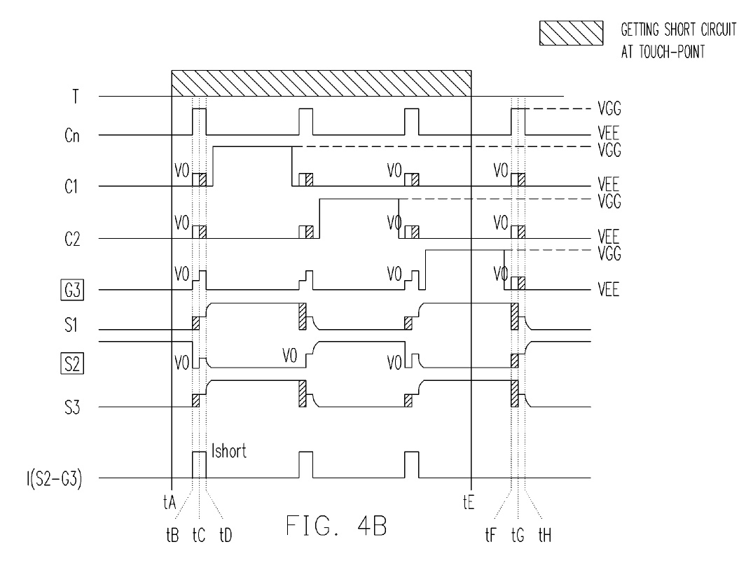

FIG. 4A is a schematic drawing of a touch screen LCD device with 480×240 resolution of another embodiment. The touch screen LCD device includes a bidirectional vertical line driver 410, a bidirectional horizontal line driver 420, a plurality of touch-point circuits 430, a plurality of pixel units 440 and a plurality of high-voltage switches 450. When a medium turns on a touch-point circuit 430 and in the time between two consecutive turning-on status of a high-voltage switch 450, the bidirectional horizontal line driver 420 outputs a voltage for producing a short-circuit current Ishort required by the touch-point circuit 430 of the touch screen LCD device. Meanwhile, the bidirectional vertical line driver 410 receives the short-circuit current signal. In the time between two consecutive turning-on status of a high-voltage switch 450 (ta, tb until tc and tf, tg until th), the bidirectional vertical line driver 410 outputs a voltage for producing a short-circuit current Ishort required by the touch-point circuit 430 of the touch screen LCD device. Meanwhile, the bidirectional horizontal line driver 420 receives the short-circuit current signal. In this way, the position data of the touch-point circuit 430 of the touch screen LCD device can be obtained.

FIG. 4B is a schematic chart showing the driving sequence of three scanning touch screen horizontal lines (G1, G2, G3) and three gray-level touch screen vertical lines (S1, S2, S3) corresponding to FIG. 4A. Wherein, the control signal Cn, the sequence of the corresponding touch-point circuit 430 and the short-circuit current signal I(S2-G3) are also given.

At tA driving time, the touch-point circuit 430 is activated by a medium to be turned on. Meanwhile, three scanning touch screen horizontal lines (G1, G2, G3) all take the negative voltage VEE and the pixel unit stays at the previous gray-level voltage.

At tB of driving time, the control signal Cn is the positive high-voltage VGG, the bidirectional horizontal line driver outputs a first voltage V0 to the scanning touch screen horizontal lines (G1, G2, G3), and the source driver with a bidirectional driving way shifts to receive the vertical line signal instead of outputting the gray-level voltage. Thus, the gray-level touch screen vertical line S2 turns on and takes the first voltage V0 and produces a short-circuit current Ishort.

At tC driving time, the high-voltage switch still is on, the source driver with a bidirectional driving way outputs a second voltage V1 to the gray-level touch screen vertical lines (S1, S2, S3). Meanwhile, the bidirectional horizontal line driver shifts to receive the horizontal line signal instead of outputting the first voltage V0. Thus, the scanning touch screen horizontal line G3 turns on and takes the second voltage V1 and produces a short-circuit current Ishort.

At tD driving time, the control signal Cn takes the negative voltage VEE and the high-voltage switch is turned off. Meanwhile, the scanning touch screen horizontal lines (G1, G2, G3) all take the negative voltage VEE and the bidirectional vertical line driver outputs the gray-level voltage.

In the time from tD until tE, the high-voltage switch turns on twice. Accordingly, the bidirectional vertical line driver and the bidirectional horizontal line driver also make two signal sampling, respectively.

At tE driving time, the touch-point circuit 430 turns off due to a release action of a medium.

In the time from tF until tH, the bidirectional vertical line driver and the bidirectional horizontal line driver still stay at the signal sampling status. Since there is no medium to activate and turn on the touch-point circuit at this time, it is impossible to produce a short-circuit current Ishort.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A touch screen liquid crystal display (LCD) device, comprising:
a plurality of touch screen LCD units, each of the touch screen LCD units comprising:
a touch-point circuit activated by an input of a medium for producing a short-circuit current signal;
a pixel unit, for receiving and storing a gray-level voltage signal;
a touch screen horizontal line, for receiving a first voltage signal and transmitting the short-circuit current signal;
a scanning touch screen horizontal line, for transmitting a scanning voltage signal for turning on/off the pixel unit and transmitting the signal of the touch screen horizontal line; and
a gray-level touch screen vertical line, for receiving a second voltage signal and the gray-level voltage signal and transmitting the short-circuit current signal;
a driving region, comprising:
a bidirectional horizontal line driver, for outputting the scanning voltage signal and the first voltage signal and receiving the short-circuit current signal; and
a bidirectional vertical line driver, for outputting the gray-level voltage signal and the second voltage signal and receiving the short-circuit current signal; and
a plurality of switch units, each of the switch units comprising:
a high-voltage switch, for turning on/off the bidirectional horizontal line driver and the adjacent touch screen horizontal line; and
a control signal, for switching on/off the high-voltage switch.

2. The touch screen LCD device as recited in claim 1, wherein at an intersection of projections of the touch screen horizontal line and the gray-level touch screen vertical line, the touch-point circuit is formed, and when the touch-point circuit gets short-circuit, the first voltage signal and the second voltage signal provide a required voltage, at different time respectively, for the touch-point circuit to produce a short-circuit current.

3. The touch screen LCD device as recited in claim 1, wherein the touch-point circuit gets short-circuit or open-circuit due to an input of at least one medium including a light source, an electric field and a magnetic field, and a short-circuit current signal is generated when the touch-point circuit gets short-circuit.

4. The touch screen LCD device as recited in claim 1, wherein in the bidirectional horizontal line driver, a same circuit is in charge of both receiving and outputting signals.

5. The touch screen LCD device as recited in claim 1, wherein in the bidirectional horizontal line driver, two sets of circuits are in charge of receiving and outputting signals, respectively.

6. The touch screen LCD device as recited in claim 1, wherein in the bidirectional vertical line driver, a same circuit is in charge of both receiving and outputting signals.

7. The touch screen LCD device as recited in claim 1, wherein in the bidirectional vertical line driver, two sets of circuits are in charge of receiving and outputting signals, respectively.

8. The touch screen LCD device as recited in claim 1, wherein the high-voltage switch comprises at least one of a N-MOS (N-type metal oxide semiconductor) and a P-MOS (P-type metal oxide semiconductor).

9. The touch screen LCD device as recited in claim 1, wherein the high-voltage switch comprises a CMOS (complementary metal oxide semiconductor).

10. A system driving method, suitable for a touch screen LCD device, comprising:
inputting a change to trigger an electric variation of a touch-point circuit, and further to produce a short-circuit current signal;
determining a turn on/off status of a high-voltage switch by a control signal;
when the high-voltage switch is on, dividing the period into a first time segment and a second time segment;
when the control signal turns on the high-voltage switch, during the first time segment, a bidirectional horizontal line driver outputting a first voltage signal, further producing the short-circuit current signal when the touch-point circuit gets short-circuit, and transmitting the short-circuit current signal to a gray-level touch screen vertical line;
when the control signal still turns on the high-voltage switch, during the second time segment, the bidirectional vertical line driver outputting a second voltage signal, further producing the short-circuit current signal when the touch-point circuit gets short-circuit, and transmitting the short-circuit current signal to a touch screen horizontal line; and
when the control signal turns off the high-voltage switch, the bidirectional horizontal line driver outputting a scanning voltage signal, and the bidirectional vertical line driver outputting a gray-level voltage signal.

11. The system driving method as recited in claim 10, wherein the input change is caused by at least one medium including a light source, an electric field and a magnetic field.

12. The system driving method as recited in claim 10, wherein the control signal turns on a high-voltage switch with a positive high-voltage and turns off a high-voltage switch with a negative high-voltage.

13. The system driving method as recited in claim 10, wherein the control signal turns on a high-voltage switch with a negative high-voltage and turns off a high-voltage switch with a positive high-voltage.

14. The system driving method as recited in claim 10, wherein the control signal is a periodic signal.

15. The system driving method as recited in claim 10, wherein the control signal is a non-periodic signal.

16. The system driving method as recited in claim 10, wherein the high-voltage switch comprises at least one of an N-MOS and a P-MOS.

17. The system driving method as recited in claim 10, wherein the high-voltage switch comprises a CMOS.

18. The system driving method as recited in claim 10, wherein the first time segment is prior to the second time segment.

19. The system driving method as recited in claim 10, wherein the second time segment is prior to the first time segment.
